(19) United States
(12) Patent Application Publication
(10) Pub. No.: US 2017/0019783 A1
(43) Pub. Date: Jan. 19, 2017

(54) Hand held electronic device with Near field communication element and associated sensor

(71) Applicant: Motorola Mobility LLC, Chicago, IL (US)

(72) Inventors: James A. Van Bosch, Crystal Lake, IL (US); Iyengar Sriram Kaushik, Buffalo Grove, IL (US); Pavel Shostak, Evanston, IL (US)

(21) Appl. No.: 14/797,418

(22) Filed: Jul. 13, 2015

(51) Int. Cl. H04W 12/06; H04W 4/00; H04L 29/06; H04B 5/00

(52) U.S. Cl. CPC H04W 12/06; H04B 5/0031; H04W 4/008; H04W 4/005; H04L 63/0861

(57) ABSTRACT

The present invention provides a hand held electronic device, which includes a near field communication element located proximate a top of the device, that is adapted for being selectively enabled. The hand held electronic device further includes a user identification sensor, which in at least some instances is a further near field communication element, and is adapted for confirming the identity of an authorized user of the device. The user identification sensor is located in a user holding area at a back side surface of the device. The user identification sensor is adapted for sensing a user interaction in an area proximate the back side surface of the device and receiving as part of the interaction, user identification information corresponding to a particular user presently using the device, and determining whether the user identification information corresponding to the particular user matches identification information for a predetermined authorized user. Upon confirming the identity of an authorized user of the device by the user identification sensor, the near field communication element located proximate the top of the device is enabled. When the identity of an authorized user of the device is not confirmed by the user identification sensor, the near field communication element located at the top of the device is not enabled.

### FIELD OF THE INVENTION

The present invention relates generally to hand held electronic devices with a near field communication element, and more particularly, to hand held electronic devices which include a near field communication element and an associated sensor, which can include a further near field communication element.

### BACKGROUND OF THE INVENTION

Near field communication, often abbreviated as NFC, refers to a short range wireless connectivity technology that enables convenient short-range communications between multiple devices, and/or a device and a tag. The communications often involve an inductive coupling which allows a signal to be conveyed between the two devices, and/or the device and the tag. More specifically, near field communications often involve magnetic induction between respective antennas located within each other's near field, such as respective loop antennas, which effectively form an air core transformer. In such an instance, a signal generated in a first communication element can be detected in the second communication element provided the two elements are in a compatible orientation, and are within relative close proximity, typically within 10 centimeters or less. In some instances, it may be possible for the two interacting devices to respectively supply and derive power through the inductive coupling, which can enable a device to read data out of a passive element including some forms of tags that do not otherwise have their own source of power. Many hand held electronic devices, such as cellular radio frequency communication devices have incorporated near field communication capabilities.

Given the proximity and interaction requirements of near field communications, and the need for the near field communication antennas to be integrated in a device with other electronic and mechanical components including user interface elements, the location and orientation of the near field communication elements with respect to the device can affect the relative performance and capabilities of the near field communication elements. The inclusion of near field communication capabilities in at least some hand held devices, such as cellular radio frequency communication devices, have generally followed one of two approaches. A first approach has incorporated a near field communication element toward the center of the back side surface of the device with an area of interaction proximate thereto, while a second approach has alternatively incorporated a near field communication element toward the top side surface of the device.

Each approach will generally have their own set of advantages and disadvantages in their convenience and performance when being used with various tags and readers including the manner in which the device can be conveniently held by the user to facilitate interaction with the other communication elements. For example, for a device having a near field communication element near the top surface of the device, by cupping the device within one's hand across the back of the device, one might more readily orient the device, such that the top of the device can be pointed toward a detection surface of a near field communication reader. However, the top of the device can commonly include other communication elements, such as one or more other antennas, which may need to share space with a near field communication antenna that is co-located at or near the top of the device. This can impact how one designs the various communication elements, as well as impact how the various communication elements function whether separately or together. Alternatively, near field communication elements located toward the center of the back side surface of a device may make it easier to interact with a second device having a similarly located near field communication element, where it may be easier to hold the two devices together in back to back fashion in order to facilitate a transfer of data between the two devices via their respective near field communication elements. The position of the interacting near field communication element proximate the back surface will provide a different set of limitations, challenges and/or opportunities as to the nature and shape of the elements, which can be used to support near field communications.

Near field communications have at least four primary operational modes of use: (1) card emulation mode; (2) tag reading; (3) tag writing; and (4) peer-to-peer. In turn, the near field communication elements can be used, for example, to enable users to use their near field communication equipped devices to support making payments through touching or bringing their phones within proximity of a near field communication reader, to support swapping contact information by touching or bringing their device within proximity of other near field communication equipped devices, and to unlock their devices and/or to confirm the identity of the user by touching or bringing their device with proximity of a near field communication tag. Some devices might only support one of the operational modes and/or use cases, while other devices might support more and sometimes all of the use cases. Use agreements for some operating system, such as the use agreement for Android, and/or some service providers including some US carriers may generally require that a particular device support a full complement of the above near field communication operational modes, as well as one or more of the corresponding use cases. Furthermore, when using the near field communications to support making a payment, the inventors have recognized that it may be desirable to also be able to support confirming the identity of the user. However, because near field communications are proximity based, it may be difficult for the same near field communication element to simultaneously support interacting with a payment reader, while also confirming the identity of the user. More generally, when a particular near field communication element is being utilized for one type of use, it can be difficult for the same element at the same time to support a further usage including in some instances a second type of use or a second operational mode. As such, there is a challenge to develop a near field communication strategy that can be as flexible as necessary or desired to meet the established operational requirements, and/or in order to meet user expectations.

Relatively recently, near field communication chip set suppliers have introduced a feature called active load modulation, which allows different near field communication antenna options in addition to the more traditional loop antennas. In at least some instances, active load modulation has also allowed the near field communication antenna to become relatively smaller, and even in some instances for the antenna to share structure with another antenna. However, active load modulation near field communication antennas are generally more suitable to one of the primary use cases, namely card emulation mode, and is generally less suitable to some of the other use cases, which can also complicate the same element supporting multiple uses and/or modes, whether simultaneously or otherwise.

The present inventors have correspondingly recognized that integrating near field communication capabilities proximate the top of a device in conjunction with an associated sensor, which can include a further near field communication element, near the back side surface of the device would be beneficial.

### SUMMARY OF THE INVENTION

The present invention provides a hand held electronic device, which includes a near field communication element located proximate a top of the device, that is adapted for being selectively enabled. The hand held electronic device further includes a user identification sensor, which is adapted for confirming the identity of an authorized user of the device. The user identification sensor is located in a user holding area at a back side surface of the device. The user identification sensor is adapted for sensing a user interaction in an area proximate the back side surface of the device and receiving as part of the interaction, user identification information corresponding to a particular user presently using the device, and determining whether the user identification information corresponding to the particular user matches identification information for one of the predetermined authorized users. Upon confirming the identity of an authorized user of the device by the user identification sensor, the near field communication element located proximate the top of the device is enabled. When the identity of an authorized user of the device is not confirmed by the user identification sensor, the near field communication element located at the top of the device is not enabled.

In at least one embodiment, the user identification sensor is a second near field communication element.

The present invention further provides a hand held electronic device, which includes a first near field communication element located proximate a top of the device, where the first near field communication element is adapted to operate in a card emulation mode for supporting a contactless card payment. The hand held electronic device further includes a second near field communication element located proximate a back side surface of the device, where the second near field communication element is adapted to operate in one or more modes different than the card emulation mode for which the first near field communication element is adapted to operate.

In at least one embodiment, the hand held electronic device still further includes a controller, which has a separate interface with each of the first near field communication element and the second near field communication element, where the controller can independently enable/disable the first near field communication element and the second near field communication element.

In at least a further embodiment, the second near field communication element is adapted for confirming the identity of an authorized user of the device through an interaction with an identity confirming smart tag, where when the identity of the user is confirmed to be an authorized user, the first near field communication element is selectively enabled.

The present invention still further provides a method for managing the operation of multiple near field communication elements in a hand held electronic device. The method includes storing identification information for one or more predetermined authorized users. A user interaction in an area proximate the back side surface of the device is sensed and as part of the interaction, user identification information corresponding to a particular user presently using the device is received. An identity of the present user of the device is confirmed as being an authorized user of the device by a user identification sensor, the user identification sensor being located in a user holding area at a back side surface of the device, by determining whether the user identification information corresponding to the particular user matches the stored identification information for one of the predetermined authorized users. Upon confirming the identity of the present user of the device as being an authorized user of the device by the user identification sensor, a near field communication element located proximate a top of the device, which is adapted for being selectively enabled, is enabled, and the near field communication element located at the top of the device, when the identity of the present user of the device is not confirmed by the user identification sensor as being an authorized user of the device is not enabled.

These and other objects, features, and advantages of this invention are evident from the following description of one or more preferred embodiments of this invention, with reference to the accompanying drawings.

### BRIEF DESCRIPTION OF THE DRAWINGS

FIG. 1 is a front view of an exemplary hand held electronic device;

FIG. 2 is a back view of an exemplary hand held electronic device, which could correspond to the hand held electronic device illustrated in FIG. 1;

FIG. 3 is a perspective view of the exemplary hand held electronic device with a near field communication element located proximate the top of the device for interacting with a near field communication payment reader;

FIG. 4 is a side view of a pair of exemplary hand held electronic devices brought within proximity to one another, where the devices are adapted and arranged for communicating via respective near field communication elements located proximate the back surface of each of the respective devices;

FIGS. 5A and 5B are respective halves of a block diagram of a hand held electronic device in accordance with at least one embodiment;

FIG. 6 is a circuit diagram of near field communication circuitry, which includes circuitry for converting between a balanced signal and an unbalanced signal;

FIG. 7 is an exemplary polling loop for a single near field communication antenna coil, where the single near field communication antenna coil is adapted for supporting multiple near field communication modes including a card emulation mode;

FIG. 8A is an exemplary polling loop, where a single near field communication antenna is adapted for exclusively supporting a card emulation mode;

FIG. 8B is an exemplary polling loop, where a single near field communication antenna coil is adapted for supporting multiple near field communication modes exclusive of a card emulation mode; and

FIG. 9 is a flow diagram of a method for managing the operation of multiple near field communication elements in a hand held electronic device.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated. One skilled in the art will hopefully appreciate that the elements in the drawings are illustrated for simplicity and clarity and have not necessarily been drawn to scale. For example, the dimensions of some of the elements in the drawings may be exaggerated relative to other elements with the intent to help improve understanding of the aspects of the embodiments being illustrated and described.

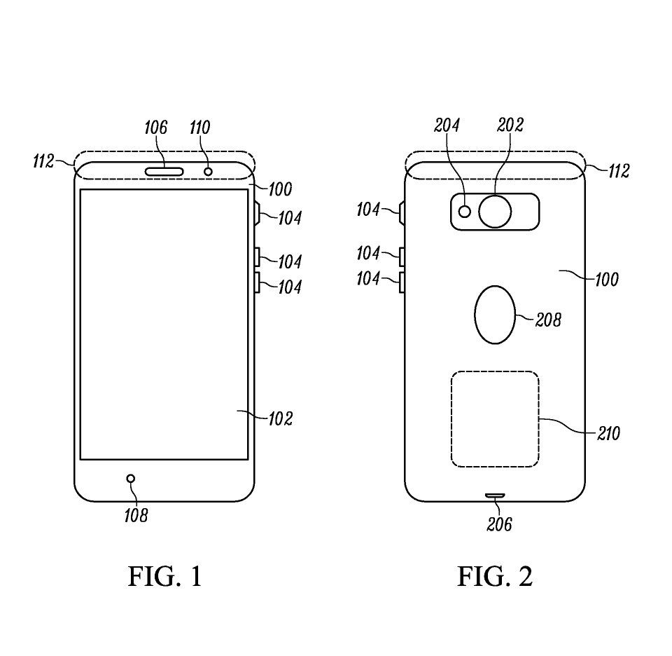

FIG. 1 illustrates a front view of an exemplary hand held electronic device 100. While in the illustrated embodiment, the type of hand held electronic device shown is a radio frequency cellular telephone, which incorporates near field communication capabilities, other types of devices that incorporate near field communication capabilities are also relevant to the present application. In other words, the present application is generally applicable to hand held electronic devices beyond the type being specifically shown. A couple of additional examples of suitable hand held electronic devices that may additionally be relevant to the present application in the incorporation and management of near field communication in a hand held electronic device can include a tablet, a cordless telephone, a selective call receiver, an audio player, a gaming device, a personal digital assistant, as well as any other form of hand held electronic device that one might at least sometimes carry around on one's person for which it might be desirable to engage in one or more forms of near field communications.

In the illustrated embodiment, the radio frequency cellular telephone includes a display 102 which covers a large portion of the front facing. In at least some instances, the display can incorporate a touch sensitive matrix, that facilitate detection of one or more user inputs relative to at least some portions of the display, including interaction with visual elements being presented to the user via the display 102. In some instances, the visual element could be an object with which the user can interact. In other instances, the visual element can form part of a visual representation of a keyboard including one or more virtual keys and/or one or more buttons with which the user can interact and/or select for actuation. In addition to one or more virtual user actuatable buttons or keys, the device 100 can include one or more physical user actuatable buttons 104. In the particular embodiment illustrated, the device has three such buttons located along the right side of the device.

The exemplary hand held electronic device, illustrated in FIG. 1, additionally includes a speaker 106 and a microphone 108 in support of voice communications. The speaker 106 may additionally support the reproduction of an audio signal, which could be a stand-alone signal, such as for use in the playing of music, or can be part of a multimedia presentation, such as for use in the playing of a movie, which might have at least an audio as well as a visual component. The speaker may also include the capability to also produce a vibratory effect. However, in some instances, the purposeful production of vibrational effects may be associated with a separate element, not shown, which is internal to the device. Generally, the speaker is located toward the top of the device, which corresponds to an orientation consistent with the respective portion of the device facing in an upward direction during usage in support of a voice communication. In such an instance, the speaker 106 might be intended to align with the ear of the user, and the microphone 108 might be intended to align with the mouth of the user. Also located near the top of the device, in the illustrated embodiment, is a front facing camera 110. Still further, the top of the device can include one or more antennas, and in the present instance an antenna for at least one near field communication will be present proximate 112 the top of the device. Such a placement enables the device to interact with at least some near field communication readers by pointing the top of device toward and proximate to the reader.

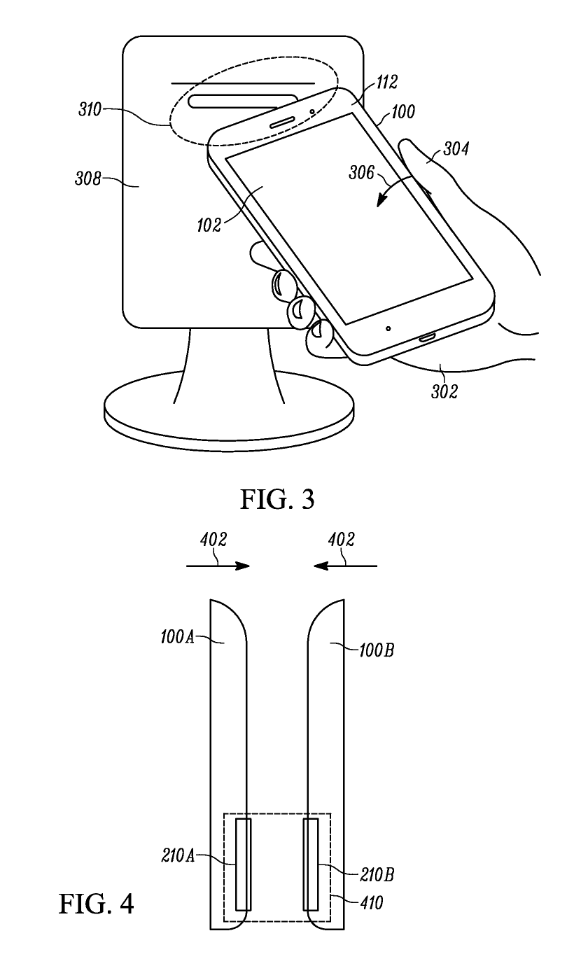

FIG. 2 illustrates a back view of the exemplary hand held electronic device 100, illustrated in FIG. 1. In the back view of the exemplary hand held electronic device, the three physical user actuatable buttons 104, which are visible in the front view, can similarly be seen. The exemplary hand held electronic device additionally includes a back side facing camera 202 with a flash 204, as well as a serial bus port 206, which is generally adapted for receiving a cable connection, which can be used to receive data and/or power signals. Still further, the illustrated embodiment includes a finger print sensor 208, which can be used to read the finger print of a user holding the device, as well as a user holding area 210 proximate the back side surface, within which a second near field communication element, such as a loop antenna, can be located within the device, often just below the back side surface of the device.

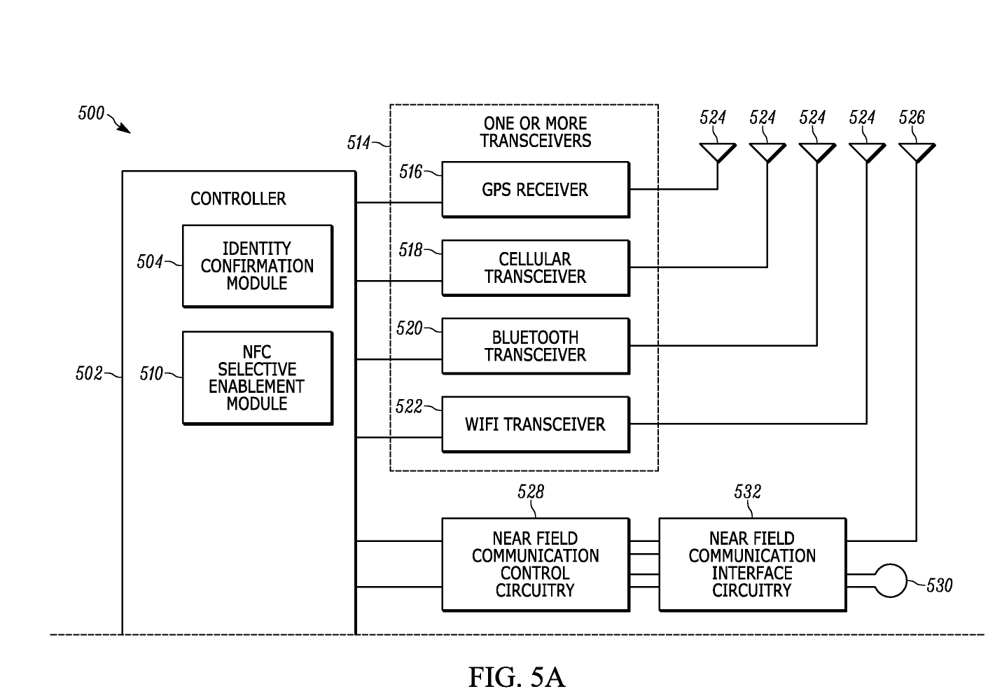

The device can be received within the palm 302 of a user as seen in FIG. 3, with the user's palm facing the back side surface of the device 100. In such an arrangement, the hand holding the device can interact with one or both of the finger print sensor 208 and the area 210 within which a second near field communication element can be located. For example, the portion of the finger tip that includes the user's fingerprint can interact with the sensor 208 in order that the ridges and grooves on the surface of the finger tip might be read. The pattern formed thereby can then be captured. The captured fingerprint pattern can then be compared against one or more fingerprints stored in memory, which are known to be associated with one or more authorized users. The user could additionally carry within the user's hand, which is being held against the back surface of the device 100, a near field communication tag that might be read by a near field communication reader element located proximate the user holding area 210 on the back side surface of the device 100. The data, which could be read from the tag, might similarly be linked to an authorized user, which could be used to confirm the identity of the user that is currently interacting with the device 100. In some instances, the tag might take the form of a ring being worn by the user, which could be positioned proximate the near field communication tag reader. One such example of a ring being used as a tag is described in Van Bosch et al., US Patent Application Publication No. US2014/0266624, entitled “Wearable Authentication Device”, the contents of which is incorporated herein by reference.

In some instances, the presence of the ring might further activate the front facing camera to capture an image of the person using the device as a further check of the current user's identity. The image could then be compared against one or more prestored images of authorized users through one or more forms of facial recognition. Still further, the detection of a Bluetooth® accessory known to be associated with a particular user could also be used in support of identifying a particular user as being an authorized user. The Bluetooth® accessory could be worn by the person, such as on a keychain being carried by the person.

Furthermore with the user's palm facing toward the back side surface, as shown in FIG. 3, the front side of the device 100 including the display 102 is generally unobstructed and can be readily seen by the user. Still further, the user's thumb 304 on the hand holding the device 100 has some degree of freedom to swipe 306 across at least a portion of the front surface, which could allow the thumb 304 to potentially interact with one or more elements being displayed via an associated touch sensitive array. Further yet, the user could use an alternate hand to interact with portions of the display 100. However, as held, the top of the device could be tilted away from the user pointing toward a separate near field communication reader, such as a payment reader 308. This could allow an enabled near field communication element, such as an antenna, located proximate the top of the device 100, to interact with a corresponding near field communication antenna located in the payment reader 308 to provide an inductive coupling via which information, such as payment transaction information, could be exchanged. It is further envisioned that the identification confirming information, that can be received by a sensor, such as the finger print sensor 208, the camera 110, a Bluetooth® transceiver 520, and/or the second near field communication element could be used by the device to selectively enable the near field communication element proximate the top of the device.

Given the space constraints near the top 112 of the device 100, as well as the need to fit other elements in the same or surrounding space, near field communication elements in this area often involve a single ended design, which is more suitable for supporting a card emulation mode using active load modulation. In at least some instances, the same antenna which supports the near field communications is also used to support the cellular radio frequency communications with the feed point for the corresponding near field communication being inductively coupled to the antenna structure. Often times such a configuration is limited to mobile payment type applications, as the antenna design and location may not be sufficient for tag read/write or peer-to-peer type near field communication applications, which often more optimally include a ferrite structure behind the antenna structure, which if used near the top of the phone might degrade the performance of the cellular antenna. In any event, a near field antenna proximate the top 112 of the device, together with a near field antenna located in the payment reader, when brought together can form the air core transformer like structure 310, that supports the inductive coupling needed to support at least some forms of near field communication.

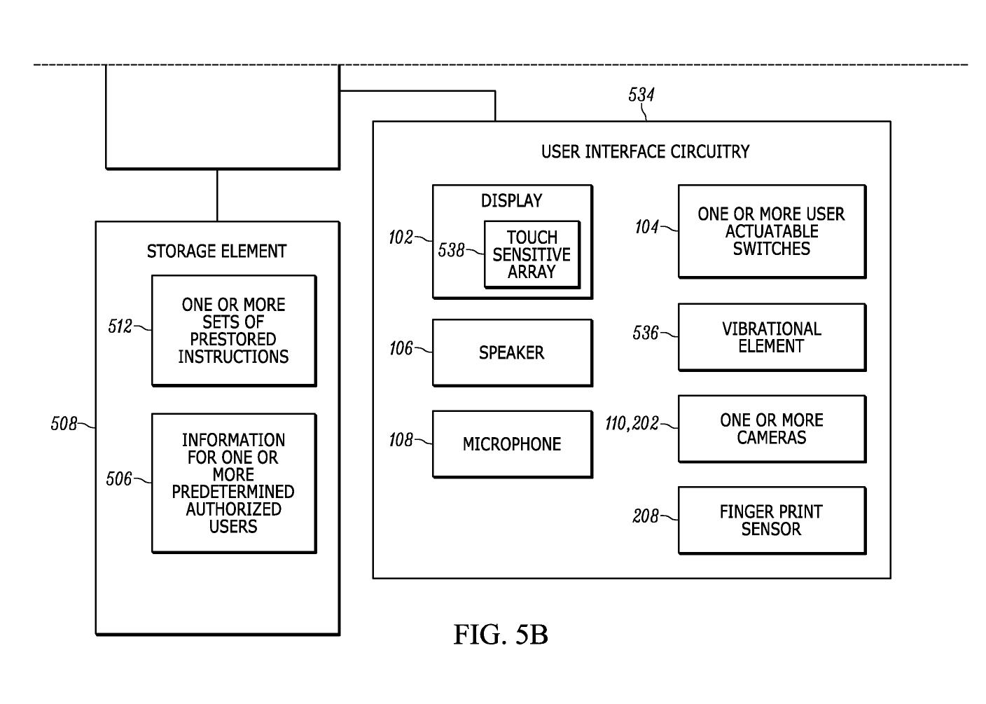

FIG. 4 illustrates a side view of a pair of exemplary hand held electronic devices 100A and 100B brought 402 within proximity to one another, where the devices are adapted and arranged for communicating via respective near field communication elements located proximate the back surface of each respective device. While the top of the device offers little room and a fair amount of interference from other device, the respective area 210A and 210B proximate the back of the device can often more readily accommodate, a more traditional loop type near field communication antenna where together the antenna loops for both of the devices being held in close proximity form a transformer like structure 410, which is better adapted for supporting peer-to-peer and tag read/write near field communication modes. Furthermore, it is generally more convenient for the users to bring two devices together in back to back fashion for purposes of supporting near field communication and the corresponding exchange of data.

By incorporating a second set of near field communication elements, the device 100 can more readily support multiple forms of near field communications with greater convenience for the user, as well as support a new use case where the two sets of near field communication elements work in tandem to support new desirable functionality. For example, as noted above, the near field communication elements associated with the area 210 proximate the back side surface of the device could be used to interact with a user identity confirming tag, which when detected could be used to trigger the enablement of the near field communication element located in the area 112 proximate the top of the device 100 for interacting with a payment reader 308. Such an arrangement could serve to provide enhanced security relative to the processing of payments via an exchange of information through near field communications, which is made possible through the inclusion of an identity confirming aspect supported through a separate sensor, such as a finger print sensor 208 or a second near field communication element.

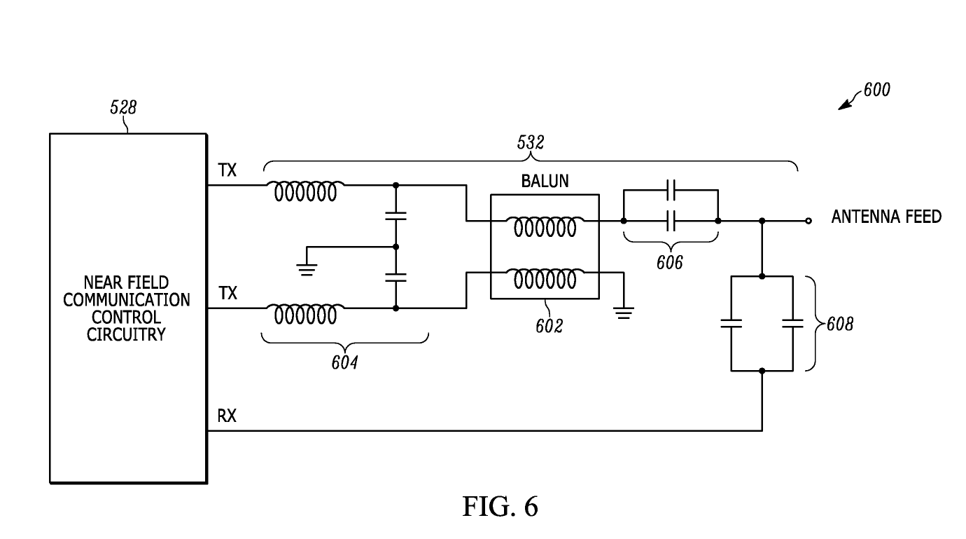

FIGS. 5A and 5B, together, illustrates a block diagram 500 of a hand held electronic device 100, in accordance with at least one embodiment. In the illustrated embodiment, the hand held electronic device 100 includes a controller 502, which is adapted for managing at least some of the operation of the device 100 including an identity confirmation module 504, which is adapted and arranged for receiving user information and comparing it against information for one or more predetermined authorized users 506, that could be stored in a storage element 508. In the illustrated embodiment, the controller 502 additionally includes a near field communication element selective enablement module 510, which is adapted to instruct the near field communication circuitry 528 to selectively enable and disable one or more of the near field communication elements. In at least some instances, the controller will enable a near field communication element having an area 112 of interaction located proximate a top of the device upon confirming the identity of the present user of the device as being an authorized user of the device by a user identification sensor, such as a finger print sensor 208, or a further near field communication element, which might have its area 210 of interaction located proximate the back side surface of the device 100.

In some embodiments, the controller 502 could be implemented in the form of one or more microprocessors, which are adapted to execute one or more sets of pre-stored instructions 512, which may be used to form or implement the operation of at least part of one or more controller modules 504 and/or 510. The one or more sets of pre-stored instructions 512 may be stored in a storage element 508, which while shown as being separate from and coupled to the controller 502, may additionally or alternatively include some data storage capability for storing at least some of the prestored instructions for use with the controller 502, that are integrated as part of the controller 502.

The storage element 508 could include one or more forms of volatile and/or non-volatile memory, including conventional ROM, EPROM, RAM, or EEPROM. The storage element 508 may still further incorporate one or more forms of auxiliary storage, which is either fixed or removable, such as a hard drive, a floppy drive, or a memory stick. One skilled in the art will still further appreciate that still other further forms of storage elements could be used without departing from the teachings of the present disclosure. In the same or other instances, the controller 502 may additionally or alternatively incorporate state machines and/or logic circuitry, which can be used to implement at least partially, some of the modules associated with the controller 502.

In the illustrated embodiment, the device further includes one or more transceivers 514, which are coupled to the controller 502 and which serve to manage the external communication of data including their wireless communication using one or more forms of communications. In such an instance, the transceivers will generally each be coupled to a corresponding antenna 524 via which the wireless communication signals will be radiated and received. For example, the one or more transceivers 514 might include a receiver 516 for supporting communications with a global positioning system, a transceiver 518 for supporting cellular radio frequency communications, a transceiver 520 for supporting Bluetooth® type communications, as well as a transceiver 522 for supporting Wi-Fi® type communications. Transceivers for other forms of communication are additionally and/or alternatively possible. While in the illustrated embodiment, each transceiver is shown as being associated with a separate antenna, it is possible that some antennas may be able to support multiple forms of communication, as well as potentially some forms of near field communication. For example, in at least some instances, it is envisioned that in at least some instances an antenna that supports cellular communications may also support a single turn loop antenna design 526 for use with some forms of near field communications including near field communications that might support and make use of active load modulation.

In addition to the one or more transceivers 514, the device 100 additionally includes near field communication circuitry 528, which are coupled to respective antenna structure 526 and 530 for supporting near field communications via near field communication interface circuitry 532. In at least some instances, chipsets may be available, which provide control circuitry 528 for supporting near field communications. In some instances, a separate chipset may be necessary for each near field communication element. However, the present inventors envision the possibility that a chipset may be extended to support multiple near field communication elements, each with their own set of input and output terminals. In the illustrated embodiment, the device 100 can include at least a pair of near field communication elements including one located in an area 112 proximate the top of the device corresponding to a single turn loop antenna 526 with a single ended feed point, and one located in an area 210 proximate the back side surface of the device 100 corresponding to a multi-turn loop antenna 530.

In the illustrated embodiment, the device 100 can additionally include user interface circuitry 534. For example, the user interface circuitry 534 can include a display 102, which may further support a touch sensitive array 538. The user interface circuitry may also include a speaker 106, a microphone 108, one or more user actuatable switches 104, a vibrational element 536, one or more cameras 110, 202, and a finger print sensor 208. Still further alternative and additional forms of user interface elements may be possible without departing from the teachings of the present invention.

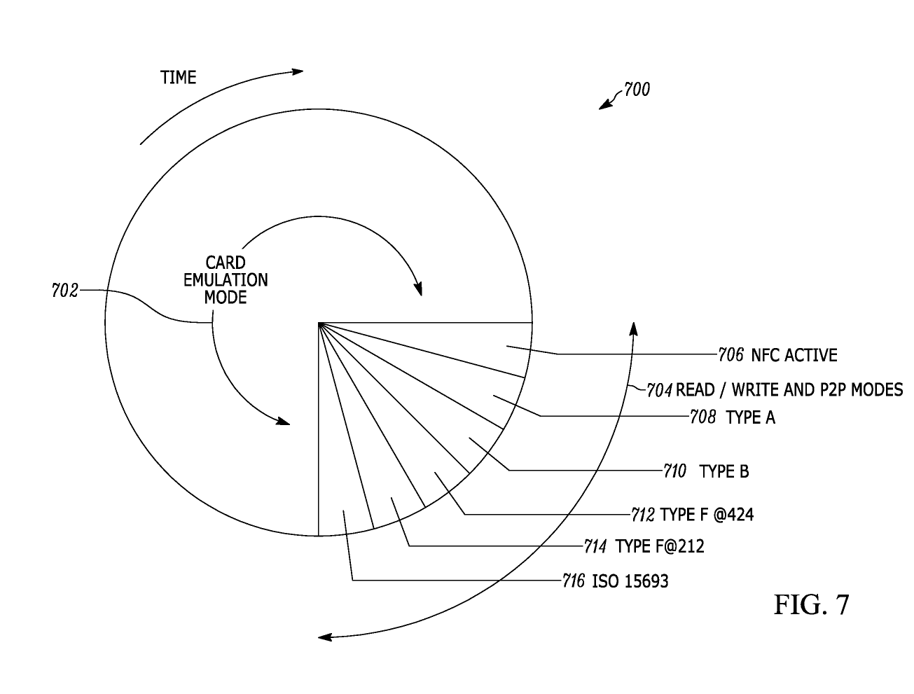

FIG. 6 illustrates a circuit diagram 600 of near field communication circuitry, which includes circuitry for converting between a balanced signal and an unbalanced signal for use with a single turn loop antenna. The conversion between a balanced signal and an unbalanced signal is achieved using a balun 602. The inductor/capacitance network 604 located between the near field communication control circuitry 528 and the balun 602, provides electromagnetic interference filtering and impedance matching, and conditions the balanced signal prior to being received by the balun 602. The output of the balun 602 is coupled to the single ended feed point via a pair 606 of capacitors in parallel. Similarly, a pair 608 of capacitors coupled in parallel connect the antenna feed point to the receive input of the near field communication circuitry 528. In each instance, it is alternatively possible for a single capacitor to be used, but a pair of capacitors give greater flexibility in tailoring the overall value of the capacitance, while still using capacitors with standard values. The pair of capacitors are used to better tune the operation with the associated antenna 526.

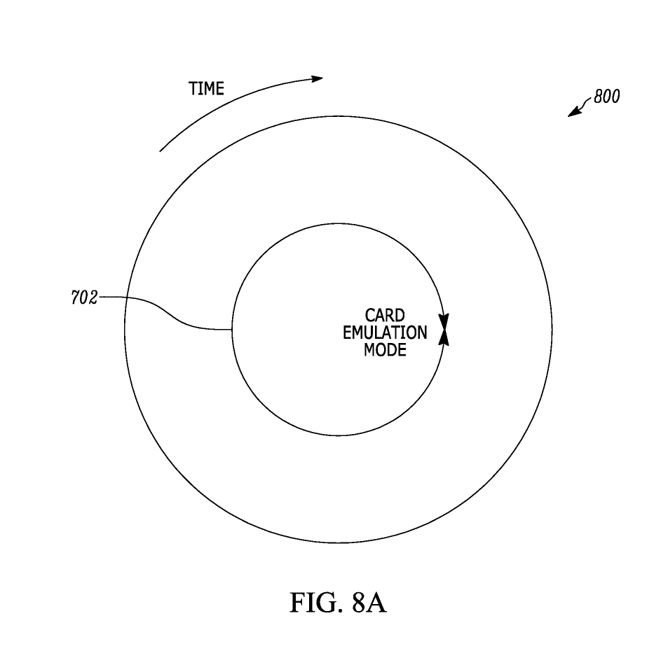

FIG. 7 illustrates an exemplary polling loop 700 for a single near field communication antenna coil, where the single near field communication antenna coil is adapted for supporting multiple near field communication modes including a card emulation mode. Such a polling loop includes a portion 702 of the time for each cycle dedicated to card emulation mode, and a portion 704 of the time for each cycle dedicated to tag read and write modes, as well as peer-to-peer (P2P) mode. Within the portion dedicated to tag read/write and P2P modes, the time portion 704 is further subdivided into various corresponding near field communication protocols including active 706, type A 708, type B 710, type F at 424 kbit/s 712, type F at 212 kbit/s 714, and ISO 15693 716, which all generally operate in the globally available unlicensed radio frequency ISM band of 13.56 MHz. Such an arrangement illustrates one possible time sharing solution when a single near field communication element needs to support multiple modes.

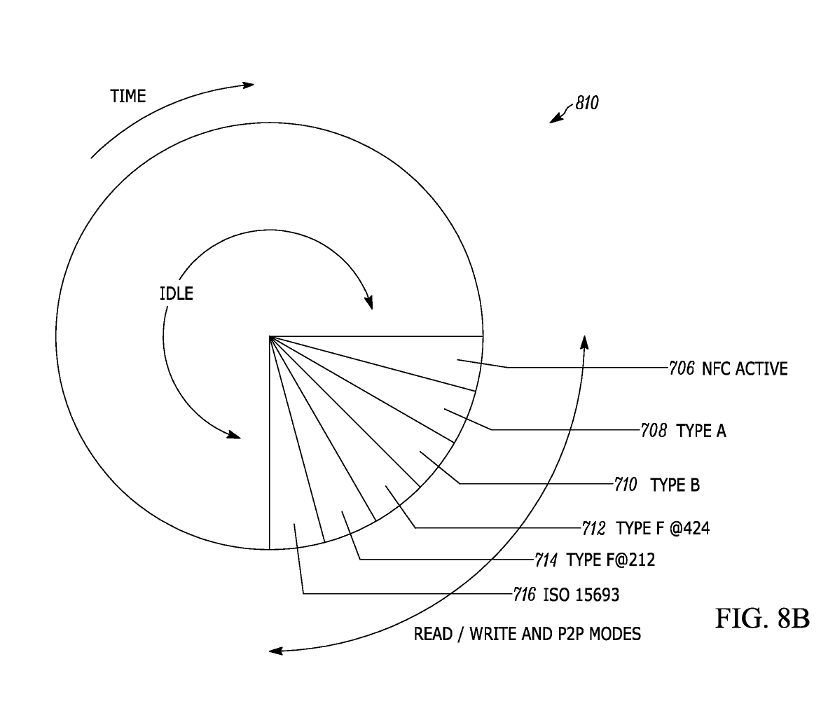

However, when multiple near field communications element are incorporated into a device, the various communication modes that need to be supported can be spread across the larger number of elements. FIGS. 8A and 8B illustrate one such exemplary redistribution when a pair of near field communication elements are available and arranged as provided in the present application. FIG. 8A illustrates an exemplary polling loop 800, where a single near field communication antenna and corresponding communication and control circuitry is adapted for exclusively supporting a card emulation mode. By dedicating more time to card emulation mode it may be possible for the corresponding near field communication to be more responsive to card payment enquiries. Furthermore, by restricting the number of modes that need to be supported to those corresponding to card emulation mode, use of a single ended feed point driving a single turn loop antenna design, which fits more readily near the top of the device, becomes a more realistic possibility. FIG. 8B illustrates an exemplary polling loop 810, where a single near field communication antenna, such as a multi-turn loop antenna, is adapted for supporting multiple near field communication modes exclusive of a card emulation mode including the modes generally having a reader/initiator phase. Such an arrangement is conducive to using a more traditional loop/coil antenna, which can be arranged proximate the back side surface of the device. During periods of time in which the corresponding near field communication circuitry is not supporting the read/write and P2P type modes, the corresponding near field communication circuitry associated with the second antenna can be put into an idle mode. By separating the near field communication functions between multiple near field communication elements, it becomes possible for the operation of one of the near field communication elements to be predicated on the result of the other near field communication element. For example, it is possible for the enablement of the near field communication element for use in supporting card emulation mode to be predicated upon a detectable user interaction with the other near field communication element, which can confirm the identity of the user as being an authorized user.

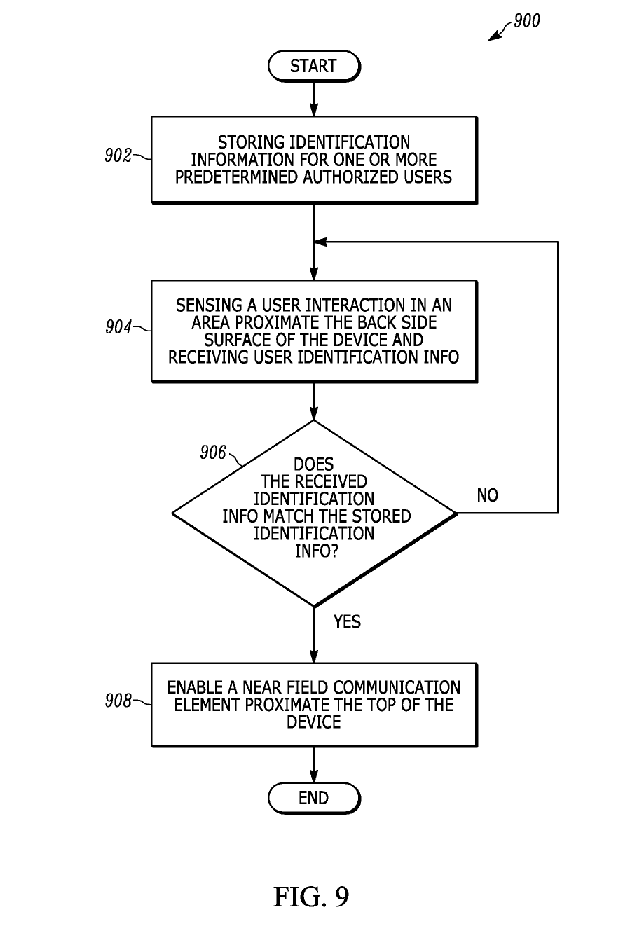

FIG. 9 illustrates a flow diagram of a method 900 for managing the operation of multiple near field communication elements in a hand held electronic device 100. The method includes storing 902 identification information for one or more predetermined authorized users, such as in a storage element 508. A user interaction in an area 210 proximate the back side surface of the device 100 is sensed 904 and as part of the interaction, user identification information corresponding to a particular user presently using the device is received. An identity of the present user of the device is confirmed as being an authorized user of the device by a user identification sensor, the user identification sensor being located in a user holding area at a back side surface of the device, such as through a determination 906 by a controller 502, as to whether the received user identification information corresponding to the particular user matches the stored identification information 506 for one of the one or more predetermined authorized users. Upon confirming the identity of the present user of the device as being an authorized user of the device 100 by the user identification sensor, a near field communication element located proximate a top 112 of the device, which is adapted for being selectively enabled, is enabled 908. The near field communication element located at the top of the device, when the identity of the present user of the device 100 is not confirmed by the user identification sensor as being an authorized user of the device is not enabled. In this way, the operation of near field communication elements in a hand held electronic device 100 can be managed.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A hand held electronic device comprising:
a near field communication element located proximate a top of the device, which is adapted for being selectively enabled;
a user identification sensor adapted for confirming the identity of an authorized user of the device, the user identification sensor being located in a user holding area at a back side surface of the device, where the user identification sensor is adapted for sensing a user interaction in an area proximate the back side surface of the device and receiving as part of the interaction, user identification information corresponding to a particular user presently using the device, and determining whether the user identification information corresponding to the particular user matches identification information for a predetermined authorized user;
wherein upon confirming the identity of an authorized user of the device by the user identification sensor, the near field communication element located proximate the top of the device is enabled, and wherein when the identity of an authorized user of the device is not confirmed by the user identification sensor, the near field communication element located at the top of the device is not enabled.

2. A hand held electronic device in accordance with claim 1, wherein the user identification sensor is a fingerprint sensor adapted for sensing a fingerprint of the particular user presently using the device, and comparing the sensed fingerprint with one or more fingerprints corresponding to one or more predetermined authorized users.

3. A hand held electronic device in accordance with claim 1, wherein the user identification sensor is a second near field communication element.

4. A hand held electronic device in accordance with claim 3, wherein the second near field communication element is adapted for reading a value from a radio frequency identification tag.

5. A hand held electronic device in accordance with claim 4, wherein the radio frequency identification tag is embedded in an article being worn by the user in the area of a hand of the user intended to be holding the electronic device.

6. A hand held electronic device in accordance with claim 1, wherein the near field communication element located proximate the top of the device, when enabled, is adapted for operating in a card emulation mode for supporting a contactless card payment.

7. A hand held electronic device in accordance with claim 1, wherein the hand held electronic device further comprises a display located along at least a portion of a front side surface of the device, where the front side surface is opposite the back side surface.

8. A hand held electronic device in accordance with claim 7, wherein the display is a touch sensitive display, wherein the touch sensitive display has a display surface that is adapted for presenting visual information to user and detecting a user interaction proximate the display surface.

9. A hand held electronic device comprising:
a first near field communication element located proximate a top of the device, where the first near field communication element is adapted to operate in a card emulation mode for supporting a contactless card payment;
a second near field communication element located proximate a back side surface of the device, where the second near field communication element is adapted to operate in a mode different than the card emulation mode for which the first near field communication element is adapted to operate.

10. A hand held electronic device in accordance with claim 9, wherein the second near field communication element is adapted to operate in at least one of a reader mode or a writer mode, which are respectively adapted for reading information from or writing information to a smart tag.

11. A hand held electronic device in accordance with claim 10, wherein the second near field communication element is further adapted to produce a magnetic field proximate the second near field communication element, and wherein the smart tag is powered by electromagnetic induction from the magnetic field produced by the second near field communication element.

12. A hand held electronic device in accordance with claim 9, wherein the second near field communication element is adapted to operate in a peer to peer mode where two near field communication devices including the second near field communication element and another near field communication element, which is not part of the hand held electronic device, can exchange data between each other.

13. A hand held electronic device in accordance with claim 9, further comprising a near field communication controller, which has a separate interface with each of the first near field communication element and the second near field communication element, where the controller can independently enable/disable the first near field communication element and the second near field communication element.

14. A hand held electronic device in accordance with claim 13, wherein the controller relative to the second near field communication element, when active, is adapted for transitioning between different modes each having one of a plurality of different standards, which can include one or more different forms of radio frequency modulation when polling for tags or another communication device as part of a reader/initiator phase.

15. A hand held electronic device in accordance with claim 14, wherein the controller relative to the second near field communication element includes periodic idle phases during polling, where the second near field communication element is deactivated.

16. A hand held electronic device in accordance with claim 13, wherein the second near field communication element is adapted for confirming the identity of an authorized user of the device through an interaction with an identity confirming smart tag, such that when the identity of the user is confirmed to be an authorized user, the first near field communication element is selectively enabled.

17. A hand held electronic device in accordance with claim 9, wherein the first near field communication element includes a single turn loop antenna.

18. A hand held electronic device in accordance with claim 9, wherein the second near field communication element includes a multi-turn loop antenna.

19. A hand held electronic device in accordance with claim 9, wherein the hand held electronic device further comprises a display located along at least a portion of a front side surface of the device, where the front side surface is opposite the back side surface.

20. A method for managing the operation of multiple near field communication elements in a hand held electronic device, the method comprising:
storing identification information for one or more predetermined authorized users;
sensing a user interaction in an area proximate the back side surface of the device and receiving as part of the interaction, user identification information corresponding to a particular user presently using the device;
confirming an identity of the present user of the device as being an authorized user of the device by a user identification sensor, the user identification sensor being located in a user holding area at a back side surface of the device by determining whether the user identification information corresponding to the particular user matches the stored identification information for one of the predetermined authorized users;
upon confirming the identity of the present user of the device as being an authorized user of the device by the user identification sensor, enabling a near field communication element located proximate a top of the device, which is adapted for being selectively enabled, and not enabling the near field communication element located at the top of the device, when the identity of the present user of the device is not confirmed by the user identification sensor as being an authorized user of the device.
